(19) United States
(12) Patent Application Publication
(10) Pub. No.: US 2013/0226586 A1
(43) Pub. Date: Aug. 29, 2013

(54) DEVICE, SYSTEM, AND METHOD FOR AUTHENTICATING USER USING VOICE RECOGNITION

(71) Applicant: Pantech Co., Ltd., (US)

(72) Inventors: Joon Young JANG, Seoul (KR); Seung Youb Han, Seoul (KR)

(73) Assignee: Pantech Co., Ltd., Seoul (KR)

(21) Appl. No.: 13/773,056

(22) Filed: Feb. 21, 2013

(30) Foreign Application Priority Data
Feb. 24, 2012 (KR) 10-2012-0019098

(51) Int. Cl. G10L 17/00

(52) U.S. Cl. CPC G10L 17/005
USPC 704/273

(57) ABSTRACT

A user authentication device to authenticate a user by voice recognition includes: an operating unit for performing authentication by comparing a audio signal input for voice recognition with voice information of an authorized user; a noise output unit to combine a noise signal with the input audio signal; and a noise cancellation unit to combine a negative noise signal corresponding to the noise signal with the audio signal with the noise signal, and to provide the mixed signal to the operating unit. Accordingly, by using the noise signal as an encryption signal, the security of user authentication using voice recognition may be improved.

### CROSS-REFERENCE TO RELATED APPLICATION

This application claims priority from and the benefit Korean Patent Application No. 10-2012-0019098, filed on Feb. 24, 2012, which is incorporated by reference for all purposes as if fully set forth herein.

### BACKGROUND

1. Field

The following description relates to a method for authenticating a user using voice recognition and a device and a system for the same.

2. Discussion of the Background

Various techniques have been studied for user authentication. In particular, user authentication using biometric data, such as, fingerprint verification, voice recognition, and iris recognition, is used in various fields. Voice recognition is being actively studied due to its convenience and its increased recognition rate.

In conventional speaker authentication, a speaker voice or user voice input through a microphone is converted into digital data by an Analog to Digital Converter (ADC) and transmitted to a Central Processing Unit (CPU) after filtering and gain control. The CPU receiving the speaker voice compares the input signal with a user voice stored in a memory through a user authentication algorithm to verify whether the speaker is a true user or an authorized user.

However, in case of using a conventional user authentication technique, it is a possible that a person near or close to the user may record the sound source of the user during the user authentication process and may use the recorded sound source for user authentication. It is difficult to determine whether the person using the same sound source is a true user or an authorized user.

In addition, even though the conventional voice recognition uses a method for authenticating a user by recognizing the voice of the user, the voice of the user may be easily exposed when the user makes a phone call, and personal information may be easily accessed by recording the voice of the user. Therefore, there is demand for a security system for user authentication.

### SUMMARY

Exemplary embodiments of the present invention provide a user authentication device with security using an output noise signal.

Additional features of the invention will be set forth in the description which follows, and in part will be apparent from the description, or may be learned by practice of the invention.

An exemplary embodiment of the present invention discloses a user authentication device, including: a noise output unit to output a first signal and mix the first signal with an audio signal; and a noise cancellation unit to generate a second signal according to the first signal and to mix the second signal with the mixed first signal and audio signal, wherein the first signal is attenuated by the second signal,

An exemplary embodiment of the present invention also discloses a user authentication device, including: an operating unit to determine whether a received audio signal is authentic and to generate a noise signal; a noise output unit to output the noise signal to a microphone and to generate a first combined signal according to the audio signal and the noise signal; and a noise cancellation unit to generate a negative noise signal and a second combined signal according to the negative noise signal and the first combined signal, wherein the operating unit compares the second combined signal with a reference audio signal to determine whether the received audio signal is authentic.

An exemplary embodiment of the present invention also discloses a method for authentication, including: receiving an audio signal; generating a first combined signal by mixing the audio signal with a noise signal; generating a negative noise signal according to the noise signal; generating a second combined signal according to the first combined signal and the negative noise signal; and determining if the second combined signal matches a reference audio signal.

An exemplary embodiment of the present invention also discloses a system for user authentication, including: a sending unit to receive an audio signal and to generate a first combined signal according to the audio signal and a noise signal; and a receiving unit to receive the first combined signal, to generate a negative noise signal according to the sending unit, and to determine if a second combined signal matches a reference audio signal, the second combined signal being the first combined signal and the negative noise signal.

An exemplary embodiment of the present invention also discloses a method for user authentication, including: receiving an audio signal; generating a noise signal; generating a first mixed signal according to the audio signal and the noise signal; and transmitting the first mixed signal to an authentication device for user authentication.

An exemplary embodiment of the present invention also discloses a method for user authentication, including: receiving a first mixed signal including an audio signal and a noise signal from a device; generating a negative noise signal according to the device; generating a second mixed signal according to the negative noise signal and the first mixed signal; and determining if the second mixed signal corresponds to a reference audio signal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a user authentication device according to an exemplary embodiment of the present disclosure.

FIG. 2 is a waveform graph of recovering an audio signal in a noise cancellation unit of FIG. 1.

FIG. 3 is a waveform graph of recovering an audio signal in a noise cancellation unit of FIG. 1.

FIG. 4 is a block diagram of a user authentication device according to an exemplary embodiment of the present disclosure.

FIG. 5 is a block diagram of a user authentication device according to an exemplary embodiment of the present disclosure.

FIG. 6 is a block diagram of a user authentication device according to an exemplary embodiment of the present disclosure.

FIG. 7 is a block diagram of a user authentication device according to an exemplary embodiment of the present disclosure.

FIG. 8 is a block diagram of a receiving unit of a user authentication device according to an exemplary embodiment of the present disclosure.

FIG. 9 is a block diagram of a sending unit of a user authentication device according to an exemplary embodiment of the present disclosure.

FIG. 10 is a flowchart of a method for authenticating a user according to an exemplary embodiment of the present disclosure.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Hereinafter, exemplary embodiments of a method for authenticating a user using voice recognition, and a device and system for the same will be described in detail with reference to the accompanying drawings.

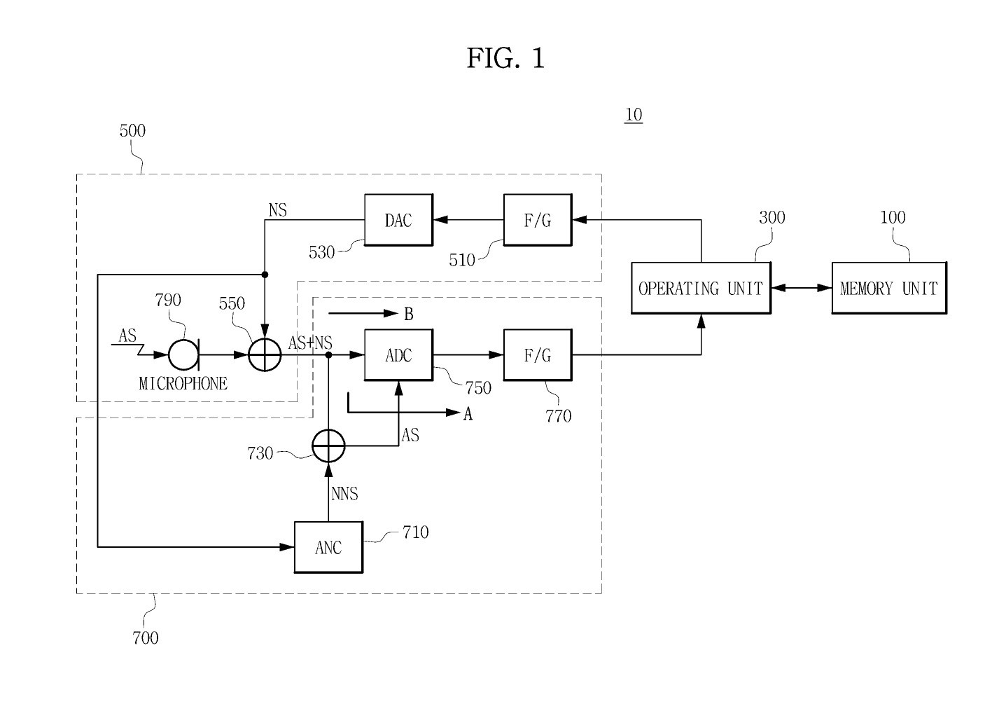

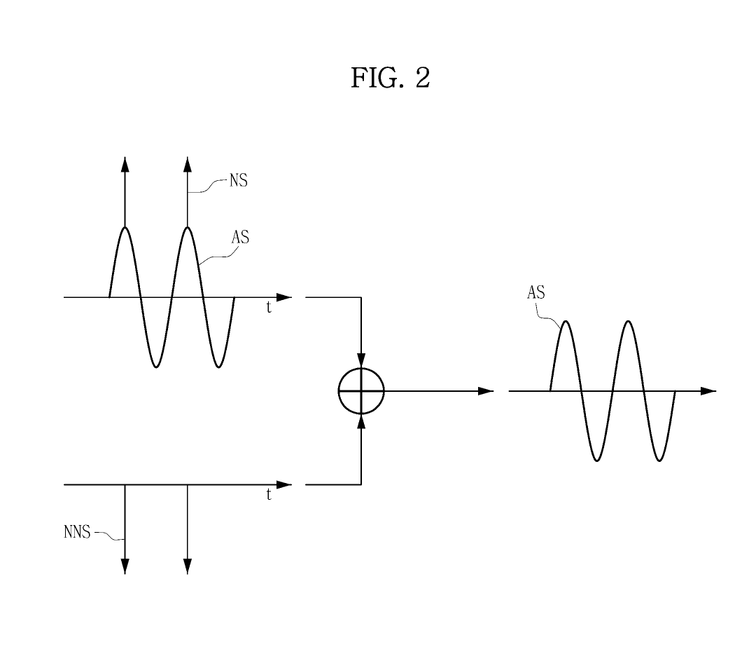

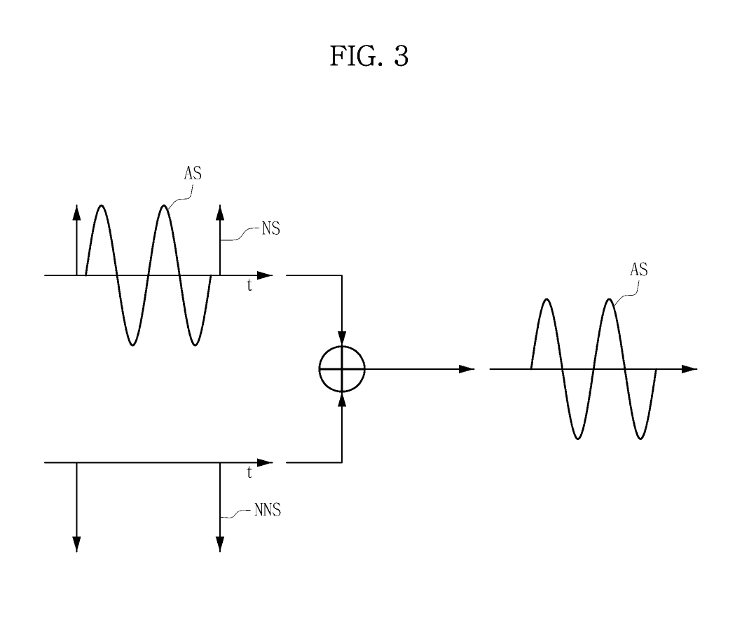

FIG. 1 is a block diagram of a user authentication device according to an exemplary embodiment of the present disclosure. FIG. 2 is a waveform graph of recovering an audio signal in a noise cancellation unit of FIG. 1. FIG. 3 is a waveform graph of recovering an audio signal in a noise cancellation unit of FIG. 1.

Referring to FIG. 1, an authentication device 10 includes an operating unit 300, a noise output unit 500, and a noise cancellation unit 700. The authentication device 10 may include a memory unit 100.

The authentication device 10 may output a noise signal as an encryption signal to a user voice, in a case where the user performs authentication or makes a phone call. Therefore, if an opponent or eavesdropper records the voice of the user, a noise signal is inserted into the recording. Even if the recorded user voice is used for user authentication, the user authentication will not be successful due to the noise signal in the recorded user voice.

The authentication device 10 may recognize a voice of a user and authenticate whether the user is a proper or authorized user, and may be installed at or connected to an interior of every kind of device which requires user authentication, such as desktop computers, smart TV, wired/wireless phones, door locks, and mobile terminals, such as, smart phones, tablet computers, net books, personal digital assistants (PDA), and portable media player (PMP), etc.

A memory unit 100 may store voice information of the user and a noise signal. The voice information of the user stored in the memory unit 100 may be voice information stored by an authorized user or a true user and may include a digital signal.

The noise signal stored in the memory unit 100 may utilize various sound sources, such as, single tone noise in an audible frequency band or an inaudible frequency band, sound source noise, noise repeating a specific pattern, etc. The noise in an inaudible frequency band may be used as the noise signal so that the user may not be inconvenienced due to the noise signal during voice recognition or while making a phone call and a person recording the user voice may not detect the generation of the noise signal. Various kinds of noises may be stored in the memory unit 100 such that a person recording the voice may not easily determine that the noise signal has been generated and may be mixed with the user voice.

A noise signal may not be separately stored in the memory unit 100. The operating unit 300 may generate the noise signal during recording of the user authentication or a phone call. The memory unit 100 may store the noise signal generated by and transmitted from the operating unit 300 such that the noise signal generated and mixed during user authentication may be determined and cancelled. The operating unit 300 may generate the noise signal based on a human body signal, such as, electrocardiogram information, brainwave information, etc.

The memory unit 100 may include at least one storage medium selected from flash memory type memories, hard disk type memories, multimedia card micro type memories, card type memories, Random Access Memory (RAM), Static Random Access Memory (SRAM), Read-Only Memory (ROM), Programmable Read-Only Memory (PROM), Erasable Programmable Read-Only Memory (EPROM), Electrically Erasable Programmable Read-Only Memory (EEPROM), magnetic memories, magnetic disks, and optic disks.

The operating unit 300 may transmit the noise signal stored in the memory unit 100 or generated by the operating unit 300 to a noise output unit 500. The operating unit 300 may select and generate or call a reference noise signal from among the noise signals stored in the memory unit 100. The operating unit 300 may generate or call the reference noise signal if user authentication is performed or may continuously call the noise signal while the authentication device 10 is in operation.

The operating unit 300 may call the noise signal from the memory unit 100 if a specific audio signal (for example, a specific word) is input. The operating unit 300 may select a noise signal arbitrarily (at random) from among the noise signals stored in the memory unit 100 and may transmit the selected noise signal to the noise output unit 500.

For example, if the authentication device 10 is installed in a smart phone or connected to the smart phone, the operating unit 300 may output the noise signal from the memory unit 100 if user authentication is performed or if a call is established.

The operating unit 300 may compare an audio signal received by the authentication algorithm with the voice information stored in the memory unit 100 and may authenticate whether a speaker of the received audio signal is a true user or authorized user. The noise signal output from the operating unit 300 and the noise signal input to the operating unit 300 may be digital signals or analog signals. The operating unit 300 may be a Central Processing Unit (CPU) of the authentication device 10.

The noise output unit 500 may output the noise signal transmitted from the operating unit 300 and may mix the transmitted noise signal with the received audio signal. The noise output unit 500 includes a Digital To Analog Converter (D/A converter) DAC 530 to convert the noise signal transmitted from the operating unit 300 into an analog noise signal (NS), and a first mixing unit 550 to mix the analog noise signal (NS) with an analog audio signal (AS) of a speaker at an output terminal of a microphone 790.

The analog noise signal (NS) may be referred to as a noise signal and the analog audio signal (AS) may be referred to as an audio signal.

The first mixing unit 550 may mix or combine the noise signal (NS) with the audio signal (AS) of the speaker received by the microphone 790 at the output terminal of the microphone 790. The first mixing unit 550 may outputs an audio signal (AS+NS) in which the noise signal and the audio signal may be mixed. The audio signal (AS+NS) where the noise signal may be mixed may be transmitted to at least one of a recipient of a phone call with the user of the authentication device 10, a third party who attempts to tap into or breaks into the authentication device 10 using a recording of the user of the authentication device 10, etc.

The noise output unit 500 may include a first filtering and gain control unit 510 to filter the noise signal transmitted from the operating unit 300, to adjust the size of the noise signal, and to provide the noise signal to the D/A converter 530. The first filtering and gain control unit 510 may perform a noise signal filtering and a gain control. Although the first filtering and gain control unit 510 is depicted as a single unit in FIG. 1, the exemplary embodiments are not limited thereto and a filtering unit and a gain control unit may be formed separately.

The first filtering and gain control unit 510 may intercept a reference frequency or allow a reference frequency to pass therethrough. For example, an infinite impulse response filter (hereinafter, referred to as an IIR filter) in which the duration of an impulse response is infinite for linearity may be used for filtering. The IIR filter may be a digital filter in which a value of an input signal and a value of an output signal are applied in a recursive feedback manner for filtering.

The duration of an impulse response may be infinite, and the IIR filter may become a circulation filter with an output feedback loop if expressed as a difference equation with a finite degree. The IIR filter with the output feedback loop may have a small degree in comparison to a design specification which may reduce the amount of calculation, and which may lead to a small load by the output feedback loop. If surrounding noises are cancelled by such a filter, the noise signal may also be filtered and cancelled. However, since the frequency band and magnitude of the generated noise signal are already known, if the noise signal is input, it may be possible to adjust a filter value of the frequency band in which the noise signal is located and the magnitude of the noise signal, which may reduce the noise signal from being filtered.

The first filtering and gain control unit 510 may amplify the noise signal based on a phase and amplitude.

A noise cancellation unit 700 may mix a negative noise signal (NNS) of the noise signal (NS) with the audio signal (AS+NS), in which the noise signal (NS) is mixed with the audio signal (AS), and may provide the mixed signal to the operating unit 300. A Feed Forward Active Noise Control (or Cancellation) unit (FF ANC), not shown, to output a noise signal may be provided to mix the noise signal (NS) with the audio signal (AS) by outputting the noise signal (NS) to the output terminal of the microphone 790 such that the noise signal (NS) is input to the speaker or the receiving unit. In an exemplary embodiment, the FF ANC unit may include both active noise control and active noise cancellation.

The noise cancellation unit 700 may include an active noise cancellation (or active noise control; ANC) unit 710, a second mixing unit 730 and an Analog to Digital Converter (A/D) converter (ADC) 750. Although not shown in FIG. 1, the noise cancellation unit 700 may include a configuration for cancelling surrounding common noise received with the audio signal (AS). In an exemplary embodiment, the ANC unit 710 may include both active noise control and active noise cancellation.

The active noise cancellation unit 710 may receive a noise signal (NS) from the noise output unit 500 and may generate a negative noise signal (NNS) of the noise signal (NS). For example, the line of the noise signal (NS) output from the noise output unit 500 may be split and the same noise signal (NS) may be input to the active noise cancellation unit 710 as input into the first mixing unit 550. The Active Noise Control (ANC) technique used by the active noise cancellation unit 710 may regard all sounds except for the sound of the voice of the user as noise and may cancel such sounds.

The negative noise signal (NNS) may be a signal with an amplitude substantially similar or identical to that of the noise signal (NS) and with a phase different therefrom, e.g., with a 180 degree phase difference from the noise signal (NS). Referring to FIG. 2 and FIG. 3, the noise signal (NS) mixed with the audio signal (AS) may be an impulse signal, and the negative noise signal (NNS) may be an impulse signal with a phase different from or opposite to that of the noise signal (NS).

Referring again to FIG. 1, the active noise cancellation unit 710 may not generate a negative noise signal (NNS) but may store a negative noise signal (NNS) for each noise signal (NS) in the memory 100.

The second mixing unit 730 may mix the negative noise signal (NNS) output from the active noise cancellation unit 710 with the audio signal (AS+NS) output from the noise output unit 500. If the negative noise signal (NNS) and the noise signal (NS) are mixed with the audio signal (AS), the negative noise signal (NNS) and the noise signal may be offset or canceled by each other and the received audio signal (AS) remains. Referring to FIG. 2 and FIG. 3, a process in which the audio signal (AS+NS) may be mixed with the negative noise signal (NNS) and the input audio signal (AS) is output is illustrated.

Referring again to FIG. 1, the A/D converter 750 may convert the audio signal (AS) output from the second mixing unit 730 into a digital audio signal and provide the digital audio signal to the operating unit 300.

The noise cancellation unit 700 may further include a second filtering and gain control unit 770 to filter the audio signal transmitted from the A/D converter 750, to adjust the size of the filtered signal and to provide the adjusted signal to the operating unit 300. The second filtering and gain control unit 770 may perform filtering to intercept or pass therethrough a reference frequency of the audio signal and gain control to amplify the noise signal based on a phase and amplitude. Although the second filtering and gain control unit 770 is depicted as a single unit in FIG. 1, similar to the first filtering and gain control unit 510, a filtering unit and a gain control unit may also be formed as separate units.

If the active noise cancellation unit 710 is activated, the noise cancellation unit 700 may proceeds via a route A in which the audio signal (AS+NS) and the negative noise signal (NNS) may be mixed and the received audio signal (AS) may be input to the A/D converter 750. If the active noise cancellation unit 710 is not activated, the noise cancellation unit 700 may proceeds via a route B in which the audio signal (AS+NS) where the noise signal is mixed or the audio signal (AS) may not be mixed with the negative noise signal (NNS) but directly input to the A/D converter 750.

Determining whether to proceed via the route A or via the route B may be determined by a user setting or a switch. For example, if the authentication device 10 is installed in a smart phone or connected to the smart phone, the active noise cancellation unit 710 may be set to operate if a user performs user authentication, so that the process may proceed via route B (not via route A) to transmit the audio signal (AS+NS) mixed with the noise signal to an opponent or a third party during user authentication. If the noise signal (NS) is a signal in an inaudible frequency band, the caller may not be influenced by the noise signal (NS).

If an audio signal is received by the operating unit from the noise cancellation unit 700, the operating unit 300 may determine whether the audio signal is authentic by an authentication algorithm to compare the received audio signal (AS) with the voice information stored in the memory unit 100. The user authentication of the operating unit 300 will be described below in detail.

If a true user or an authorized user performs user authentication as a speaker and if an analog audio signal (AS) is received by the microphone 790, the noise output unit 500 may output the noise signal (NS) to the output terminal of the microphone 790 so that the audio signal (AS+NS) may be generated. The audio signal (AS+NS) may be mixed with the negative noise signal (NNS) generated from the active noise cancellation unit 710. As a result, the noise signal (NS) may be cancelled by the negative noise signal (NNS) and the original analog audio signal (AS) may remain.

The analog audio signal (AS) may be converted into a digital audio signal and, it may be filtered and amplified. The operating unit 300 may receive the audio signal, and may compare the audio signal with a voice waveform of the voice information of the user stored in the memory unit 100 to determine whether the speaker is the true user or the authorized user.

If an opponent, eavesdropper, or a third party, who is not a true user or authorized user, records the voice of the user by calling the user, tapping into a phone call of the user, etc., the audio signal (AS+NS) may be recorded. Therefore, if performing user authentication using the recorded audio signal (AS+NS) and the audio signal (AS+NS) is received by the microphone 790, the noise output unit 500 may output a new noise signal (NS1) to the output terminal of the microphone 790 to generate an audio signal (AS+NS+NS1) mixed with two noise signals.

The active noise cancellation unit 710 may generate a new negative noise signal (NNS1) of the new noise signal (NS1), and accordingly the audio signal (AS+NS+NS1) mixed with two noise signals may be mixed with the new negative noise signal (NNS1). The new noise signal (NS1) may be cancelled by the negative noise signal (NNS1), but the recorded noise signal (NS) may not be cancelled, and the audio signal (AS+NS) with the noise signal mixed therein may remain.

If the operating unit 300 receives the audio signal (AS+NS), the operating unit 300 denies user authenticate of the person inputting the audio signal as a true user because there is a difference between the audio signal (AS+NS) and a voice waveform of the voice information of the user stored in the memory unit 100 due to the noise signal (NS).

Even if the noise signal (NS) output when the opponent or a third party records the voice of the user is identical to the new noise signal (NS1) output during user authentication, two signals are added to the audio signal (AS) and a level difference is generated by the new noise signal (NS1). Therefore, the new noise signal (NS1) may be cancelled by the negative noise signal (NNS1), and the noise signal (NS) output at recording may remain in the audio signal (AS+NS), and user authentication fails.

If the authentication device 10 is used, a noise signal may be output as an encryption signal when a user makes a phone call or performs user authentication, and if an opponent, eavesdropper, or a third party records the voice of the user by, for example, calling the user, tapping into a phone call of the user, recording a sound source from the user making a phone call, etc., and attempts user authentication with the recorded voice, the attempt may fail. Therefore, the security of the user authentication using voice recognition may be improved.

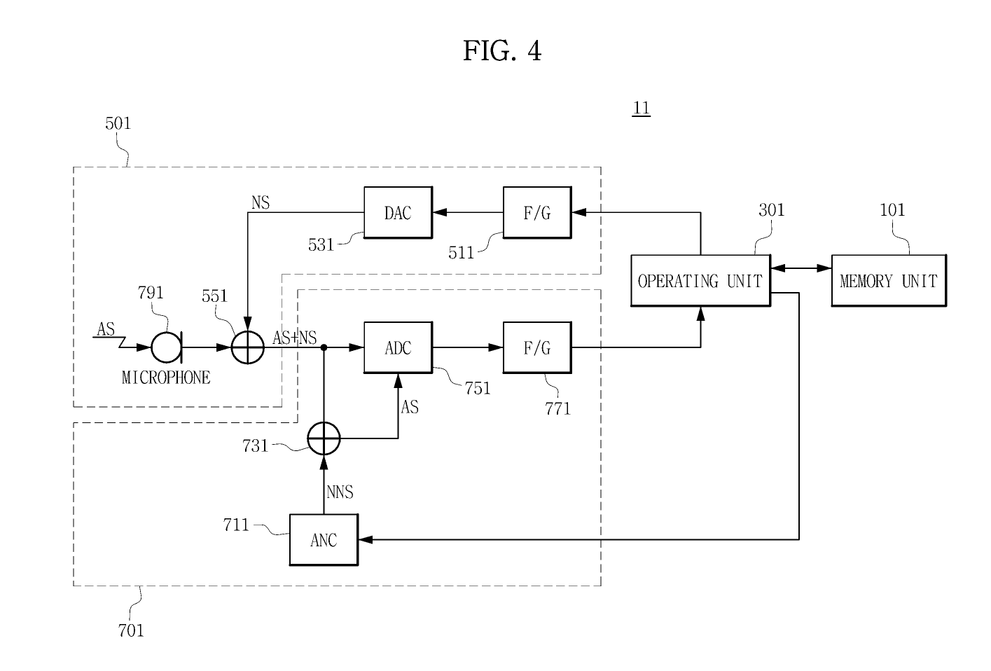

FIG. 4 is a block diagram of a user authentication device according to an exemplary embodiment of the present disclosure.

Referring to FIG. 4, an authentication device 11 may be substantially similar to the authentication device 10, except for a noise cancellation unit 701. Therefore, description of similar components will be omitted for brevity.

An active noise cancellation unit 711 of the noise cancellation unit 701 may receive a noise signal from the operating unit 301 and may generate a negative noise signal (NNS) of the noise signal. The active noise cancellation unit 710 may receive the noise signal (NS) from the noise output unit 500 in FIG. 1, and in FIG. 4, the active noise cancellation unit 711 may receive a noise signal directly from the operating unit 301.

If user authentication is performed or a user makes a phone call, the operating unit 301 may output a noise signal to a noise output unit 501 and a noise cancellation unit 701. The noise signal may be output simultaneously to the noise output unit 501 and the noise cancellation unit 701. For example, the noise signal provided by the operating unit 301 may be a noise signal stored in a memory unit 101, and may be provided to the noise output unit 501 and to the active noise cancellation unit 711. Identification information may be separately added to each noise signal. The operating unit 301 may extract the corresponding noise signal using identification information of the noise signal provided to the noise output unit 501 and may input the noise signal into the active noise cancellation unit 711.

The active noise cancellation unit 711 may receive an analog noise signal from the operating unit 301, or may receive a digital noise signal from the operating unit 301and may convert the digital noise signal into an analog noise signal. The active noise cancellation unit 711 may include a filtering and gain control unit 771 to filter the digital noise signal and to adjust a size of the digital noise signal and a D/A converter 751 to convert the digital noise signal into an analog noise signal.

If a user performs user authentication or makes a phone call using the authentication device 11, because noise signals may be output from the operating unit 301 to the noise output unit 501 and the noise cancellation unit 701 simultaneously, a process delay may be reduced in the authentication unit 11.

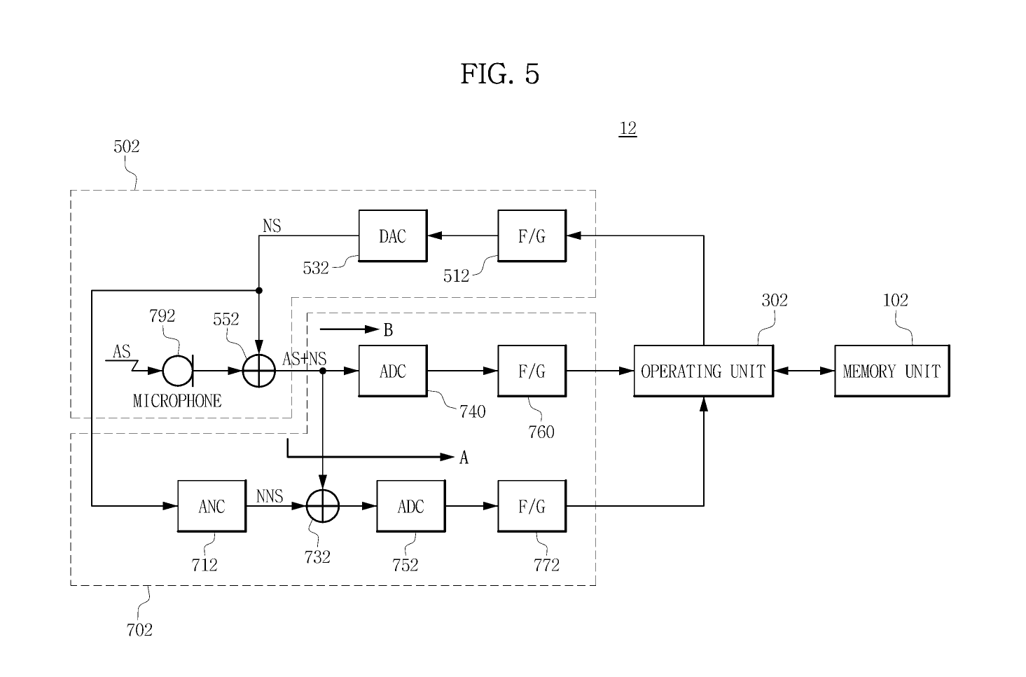

FIG. 5 is a block diagram of a user authentication device according to an exemplary embodiment of the present disclosure.

Referring to FIG. 5, an authentication device 12 may be substantially similar to the authentication device 10 of FIG. 1, except for a noise cancellation unit 702. Therefore, descriptions of similar component will be omitted for brevity.

The noise cancellation unit 702 of the authentication device 12 may include a second A/D converter 740, a third filtering and gain control unit 760, an active noise cancellation (or active noise control; ANC) unit 712, a second mixing unit 732, a first A/D converter 752, and a second filtering and gain control unit 772. In an exemplary embodiment, ANC unit 712 may include both active noise control and active noise cancellation.

If performing user authentication, the audio signal (AS+NS) from the noise output unit 502 may proceed along the route A, and during a phone call, the audio signal (AS+NS) may proceed along the route B. The route A and the route B may use a common A/D converter and filtering and gain control unit in FIG. 1, and the route A and the route B may use separate A/D converter and filtering and gain control units in FIG. 5.

If the authentication device 12 is used, the route the audio signal (AS+NS) follows may be vary depending on whether user authentication is performed in the noise cancellation unit 702 or not.

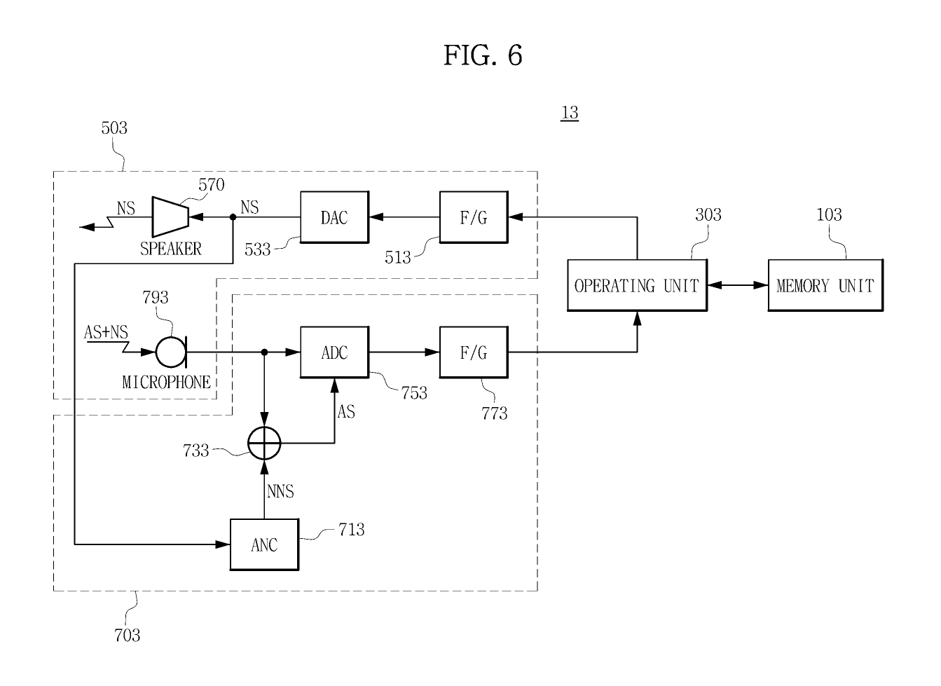

FIG. 6 is a block diagram of a user authentication device according to an exemplary embodiment of the present disclosure.

Referring to FIG. 6, an authentication device 13 may be substantially similar to the authentication device 10 of FIG. 1, except for a noise output unit 503. Therefore, description of similar components will be omitted for brevity.

The noise output unit 503 of the authentication device 13 includes a D/A converter 533 to convert the noise signal transmitted from an operating unit 303 into an analog noise signal (NS) and a speaker 570 to output the analog noise signal (NS).

The analog noise signal (NS) is mixed with the analog audio signal (AS) of the speaker at the output terminal of the microphone 790 in FIG. 1, and in FIG. 6, the analog noise signal (NS) may be output through the speaker 570 and mixed with the analog audio signal (AS) of the speaker at the input terminal of a microphone 793.

The authentication device 13 may include a Feed Back Active Noise Control unit (FB ANC), not shown, to mix the analog noise signal (NS) with the audio signal (AS) by outputting the analog noise signal (NS) through the speaker to be received by the microphone 793 and mixed with the audio signal (AS). The speaker 570 may be an internal speaker disposed in the authentication device 13 or an external speaker disposed outside of the authentication device 13. The speaker 570 may be a speaker of a terminal or a dedicated speaker to output a separate noise. In an exemplary embodiment, FB ANC unit may include both active noise control and active noise cancellation.

The noise output unit 503 may include a first filtering and gain control unit 513 to filter the noise signal transmitted from an operating unit 303, to adjust a size of the noise signal, and to provide the adjusted noise signal to a D/A converter 533.

In the authentication device 13, if user authentication is attempted by recording a sound source by, for example, calling the user, tapping into a phone call of the user, recording a sound source from the user making a phone call, etc., the attempt may fail.

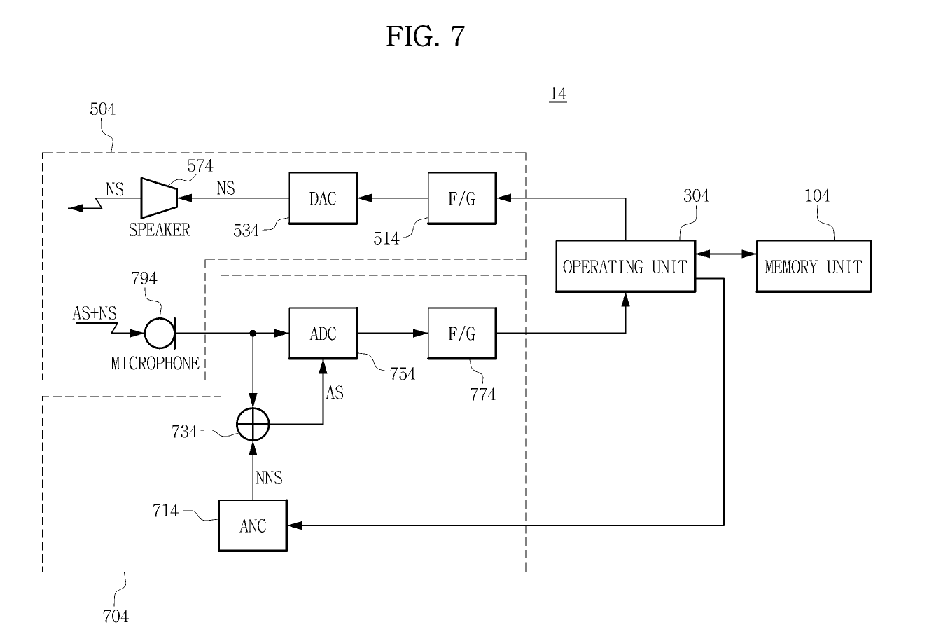

FIG. 7 is a block diagram of a user authentication device according to an exemplary embodiment of the present disclosure.

Referring to FIG. 7, an authentication device 14 may be substantially similar to the authentication device 13 of FIG. 6, except for a noise cancellation unit 704. Therefore, description of similar components will be omitted for brevity.

The active noise cancellation unit 714 of the noise cancellation unit 704 may receive a noise signal (NS) from the operating unit 304 and may generate a negative noise signal (NNS) of the noise signal (NS). The active noise cancellation unit 713 may receive the noise signal (NS) from the noise output unit 503 in FIG. 6, and the active noise cancellation unit 714 may directly receive the noise signal from the operating unit 304 in FIG. 7.

While user authentication is performed or a user makes a phone call, the operating unit 304 may output the noise signal (NS) to the noise output unit 504 and the noise cancellation unit 704 simultaneously.

The active noise cancellation unit 714 may receive an analog noise signal from the operating unit 304 or may receive a digital noise signal and may convert the digital noise signal into an analog noise signal.

In the authentication device 14, if a user performs authentication or makes a phone call, the noise signal (NS) may be output from the operating unit 304 to the noise output unit 504 and the noise cancellation unit 704 simultaneously, which may reduce a process delay in the authentication unit 14.

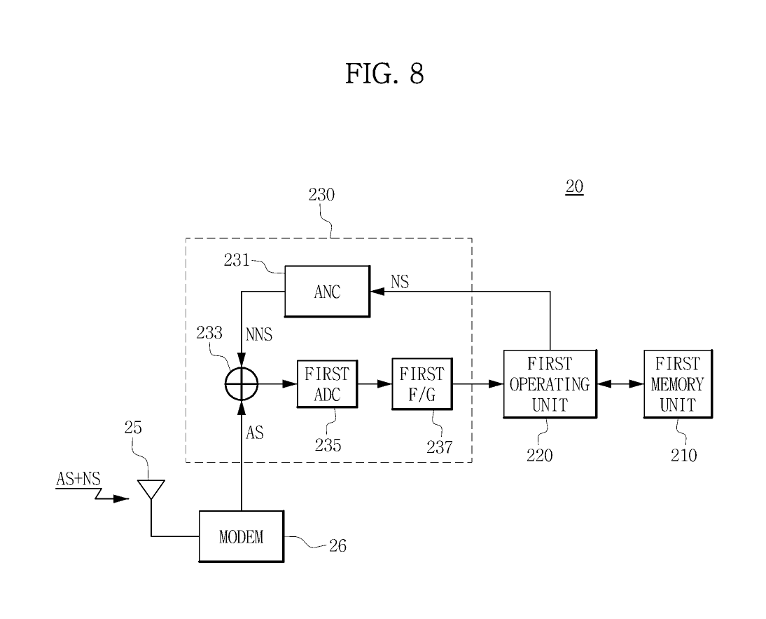

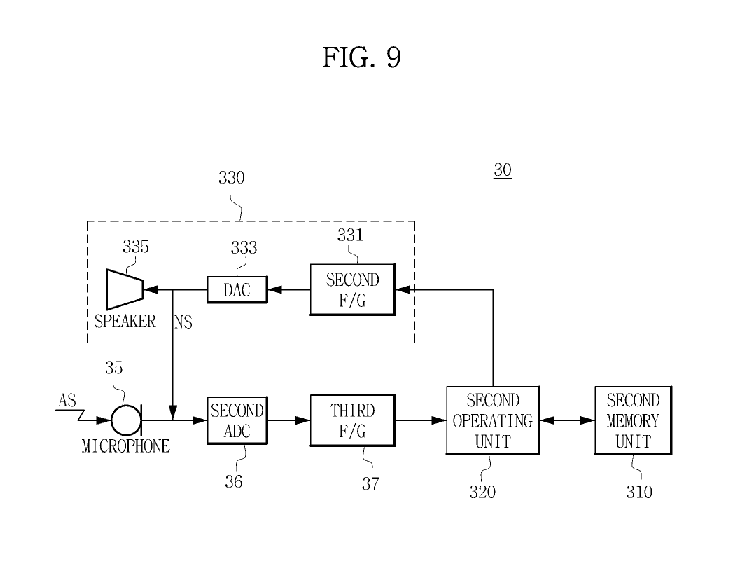

FIG. 8 is a block diagram of a receiving unit of a user authentication system according to an exemplary embodiment of the present disclosure. FIG. 9 is a block diagram of a sending unit of a user authentication system according to an exemplary embodiment of the present disclosure. Descriptions of the components of the authentication system of FIG. 8 and FIG. 9 substantially similar to components of the authentication device 10 of FIG. 1 will be omitted for brevity.

A receiving unit 20 of the user authentication system may be a control device of a user authentication institution, such as, a financial institution (e.g., a bank) and an educational institution, and the sending unit 30 may be a user terminal. The user terminal may include various user terminals having wired/wireless communication unit and mobile phones, such as, a smart phone, or a feature phone. The receiving unit 20 may determine whether the user is a true user or authorized user, according to an audio signal received through the user terminal.

Referring to FIG. 8, the receiving unit 20 of the authentication system includes a first memory unit 210, a first operating unit 220, and a noise cancellation unit 230.

The first memory unit 210 may store voice information of the user and a noise signal (NS). The receiving unit 20 of the authentication system may authenticate a plurality of sending units 30 (see FIG. 9). Voice information and noise signals corresponding to the plurality of sending units 30 may be stored in the first memory unit 210. The voice information and the noise signals of the plurality of sending units 30 may be stored separately in the first memory unit 210.

The noise signal (NS) stored in the first memory unit 210 may utilize various sound sources, such as, single tone noise in an audible frequency band or an inaudible frequency band, sound source noise, a noise repeating a specific pattern, etc. The first memory unit 210 may receive and store a noise signal (NS) generated by and transmitted by the first operating unit 220. The first operating unit 220 may generate the noise signal (NS) based on a human body signal, such as, electrocardiogram information, brainwave information, etc.

The first operating unit 220 may instruct the sending unit 30 to output a noise signal (NS) from among the stored noise signals, and outputs the noise signal (NS) to the noise cancellation unit 230. The audio signal (AS+NS) may be received from the sending unit 30 through a receiving terminal 25 and a modem 26 and may be compared with the voice information stored in the first memory unit 210 to authenticate a user.

The first memory unit 210 may store the voice information of the user and may not store the noise signal. The receiving unit 20 may receive the noise signal (NS) from the sending unit 30, and the received noise signal (NS) may be input into the first operating unit 220 to perform user authentication.

The noise cancellation unit 230 may generate a negative noise signal (NNS) of the noise signal (NS) according to the noise signal (NS) received from the first operating unit 220, and may mix the negative noise signal (NNS) with the audio signal (AS+NS) and may output the mixed signal to the first operating unit 220. The negative noise signal (NNS) may be a signal with an amplitude substantially similar to that of the noise signal (NS) and with a phase difference therefrom, for example, a 180 degree phase difference.

The noise cancellation unit 230 may include an active noise cancellation unit 231 to generate a negative noise signal (NNS) of the noise signal (NS), a mixing unit 233 to mix the negative noise signal (NNS) with the audio signal (AS+NS), and a first A/D converter 235 to convert the audio signal output from the mixing unit 233 (AS+NS+NNS) into a digital audio signal.

The noise cancellation unit 230 may further include a first filtering and gain control unit 237 to filter the digital audio signal output from the first A/D converter 235, to adjust a size of the digital audio signal, and to output the adjusted signal to the first operating unit 220.

The noise cancellation unit 230 may restore the audio signal (AS) included in a audio signal (AS+NS) with an attenuated noise signal (NS) by using the negative noise signal (NNS) and may provide the restored audio signal (AS) to the first operating unit 220. The first operating unit 220 may compare the restored audio signal (AS) with the voice information of the user stored in the first memory unit 210 to determine whether the user is a true user or an authorized user.

Referring to FIG. 9, the sending unit 30 of the authentication system includes a second memory unit 310, a second operating unit 320, and a noise output unit 330.

The second memory unit 310 may store a noise signal. The noise signal stored in the second memory unit 310 may be substantially similar to the noise signal stored in the first memory unit 210 of the receiving unit 20 of in the authentication system of FIG. 8. The first operating unit 220 of the receiving unit 20 and the second operating unit 320 of the sending unit 30 may use the same or the substantially similar sequence of outputting the noise signals stored in the first memory unit 210 and the second memory unit 310 such that the noise signals outputted by the first operating unit 220 of the receiving unit 20 and the second operating unit 320 of the sending unit 30 may be synchronized.

If the first operating unit 220 of the sending unit 20 of the authentication system of FIG. 8 instructs to output a reference noise signal (NS), the second operating unit 320 may call the reference noise signal (NS) from the second memory unit 310 and may transmit the noise signal to the noise output unit 330.

The sending unit 30 may not include the second memory unit 310, and the second operating unit 320 may receive a noise signal directly from the receiving unit 20 and use the noise signal received from the receiving unit 20.

The noise output unit 330 may output the noise signal (NS) transmitted from the second operating unit 320 and may mix the noise signal (NS) with the audio signal (AS) received by the microphone 35.

The noise output unit 330 may include a D/A converter 333 to convert the noise signal (NS) transmitted from the second operating unit 320 into an analog noise signal (NS), a mixing unit (not shown) to mix the analog noise signal (NS) with an audio signal (AS), and a speaker 335 to output the analog noise signal (NS).

The noise output unit 330 may include a second filtering and gain control unit 331 to filter the noise signal transmitted from the second operating unit 320, to adjust a size of the noise signal, and to provide the adjusted noise signal to the D/A converter 333.

The noise output unit 330 may mix the noise signal (NS) with the audio signal (AS) at the output terminal of the microphone 35. The noise output unit 330 may output the noise signal (NS) to the speaker 335 so that the noise signal (NS) is mixed with the audio signal (AS) at the input terminal of the microphone 35.

The audio signal (AS+NS) may be transmitted to the receiving unit 20 of the user authentication system of FIG. 8.

The sending unit 30 of the authentication system may include a second A/D converter 36 to convert an audio signal of the user into a digital audio signal regardless of user authentication and a third filtering and gain control unit 37 to filter the audio signal, to adjust a size of the audio signal, and to provide the adjusted audio signal to the second operating unit 320.

According to the exemplary embodiments, a financial institution or a public institution may perform user authentication by voice recognition through a terminal of a user, and the security of user authentication may be improved by using the noise signal as an encryption signal.

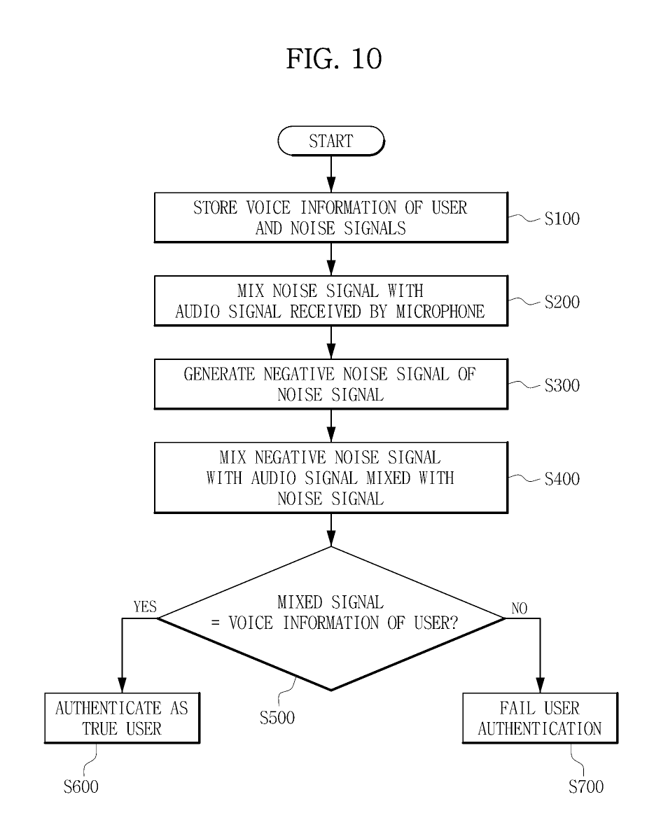

FIG. 10 is a flowchart of a method for authenticating a user according to an exemplary embodiment of the present disclosure.

Referring to FIG. 10, in operation S 100, voice information of a user and noise signals are stored. The noise signal may be a single tone noise in an audible frequency band or an inaudible frequency band, a sound source noise, a noise repeating a specific pattern, etc. The noise signal may be generated according to a human body signal, such as, electrocardiogram information, brainwave information, etc.

In operation S200, the noise signal may be mixed with an audio signal received by the microphone. The noise signal may be output when user authentication is performed or may be continuously output while a phone call is established.

Mixing the noise signal may include converting the noise signal into an analog noise signal and mixing the analog noise signal with the received audio signal. Mixing the noise signal may include filtering the noise signal and adjusting a size of the noise signal.

The noise signal and the audio signal may be mixed at the output terminal of the microphone, and the noise signal may be output to the speaker such that the noise signal and the received audio signal may be mixed at the input terminal of the microphone.

In operation S300, a negative noise signal of the noise signal is generated. The negative noise signal may have an amplitude substantially similar to that of the noise signal and have a phase different from the noise signal, for example a 180 degree phase difference. Therefore, the noise signal may be attenuated by the negative noise signal, such that the received audio signal may be restored.

If the negative noise signal is generated, in operation S400, the negative noise signal may be mixed with the received audio signal mixed with the noise signal. In operation S500, it is determined whether the mixed audio signal is identical or substantially similar to the voice information of the user.

If the mixed audio signal is identical or substantially similar to the voice information of the user, in operation S600, the user is determined as a true user or an authorized user. If the mixed audio signal is not identical or substantially similar to the voice information of the user, in operation S700, user authentication will fail.

In the method for authenticating a user, since a noise signal may be output as an encryption signal when a user makes a phone call or performs user authentication, even if an opponent, an eavesdropper, or a third party records the voice of the user by calling the user, tapping into a phone call of the user, recording a sound source from the user making a phone call, etc., and attempts user authentication, the attempt may fail. Therefore, the security of the user authentication using voice recognition may be improved.

Although the present disclosure has been illustrated based on the authentication device using voice recognition, which determines a true user or authorized user by voice information of the user, the security technique according to the present disclosure is not limited to the voice recognition device. In other words, the present disclosure may be applied to devices which record or transmit voice of a user, such as, a voice recognition device to recognize voice and to operate through voice recognition. A noise signal may be output according to a state in which the voice of the user is received, and even if a third party records the voice of the user, the use of the recorded voice for user authentication may fail.

According to the exemplary embodiments, if a user performs user authentication or makes a phone call, a noise signal may be mixed with the user voice and transmitted, and so, if an opponent or a third party records the user voice, the noise signal is recorded with the voice. In this case, even when the opponent or the third party attempts user authentication by using the recorded user voice, user authentication will fail due to the noise signal being mixed with the voice. Therefore, by using the noise signal as an encryption signal, the security of user authentication using voice recognition may be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A user authentication device, comprising:
a noise output unit to output a first signal to mix with an audio signal; and
a noise cancellation unit to generate a second signal according to the first signal and to mix the second signal with the mixed first signal and audio signal,
wherein the first signal is attenuated by the second signal.

2. The device of claim 1, further comprising:
an operating unit to determine whether the second signal mixed with the mixed first signal and audio signal matches a reference signal.

3. A user authentication device, comprising:
an operating unit to generate a noise signal and to determine whether a received audio signal is authentic;
a noise output unit to output the noise signal to a microphone, the microphone to generate a first combined signal according to the audio signal and the noise signal; and
a noise cancellation unit to generate a negative noise signal and a second combined signal according to the negative noise signal and the first combined signal,
wherein the operating unit compares the second combined signal with a reference audio signal to determine whether the received audio signal is authentic.

4. The device of claim 3, wherein, if the noise signal is attenuated by the negative noise signal, the operating unit compares the received audio signal with the reference audio signal to determine whether the received audio signal is authentic.

5. The device of claim 3, further comprising: a microphone to receive the audio signal.

6. The device of claim 3, wherein the noise output unit comprises:
a first filtering and gain control unit to filter the noise signal;
a digital to analog converter to convert the noise signal into an analog noise signal; and
a mixing unit to generate the first combined signal according to the analog noise signal and the received audio signal.

7. The device of claim 3, wherein the noise cancellation unit comprises:
an active noise cancellation unit to generate the negative noise signal; and
a mixing unit to generate the second combined signal according to the negative noise signal and the first combined signal.

8. The device of claim 3, wherein the noise cancellation unit further comprises:
a first analog to digital converter to convert the first combined signal into a digital signal, and
a second filtering and gain control unit to filter and to gain control the digital audio signal.

9. The device of claim 7, wherein the active noise cancellation unit cancels all sound except the received audio signal.

10. The device of claim 3, wherein the operating unit outputs the noise signal to the noise output unit and the noise cancellation unit simultaneously.

11. The device of claim 8, wherein the noise cancellation unit further comprises:
a second analog to digital converter to convert the first combined signal to a digital signal, and
a third filtering and gain control unit to filter and to gain control the digital signal,
wherein if the audio signal is received during user authentication, the first combined signal is output to the first analog to digital converter and the second filtering and gain control unit, and
wherein if the audio signal is received during a phone call, the first combined signal is output to the second analog to digital converter and the third filtering and gain control unit.

12. The device of claim 5, wherein the noise output unit comprises:
a speaker to output the noise signal, and
wherein the microphone receives the first combined signal according to the received audio signal and the noise signal output from the speaker.

13. The device of claim 12, wherein the operating unit outputs the noise signal to the noise cancellation unit and noise output unit simultaneously.

14. A method for authentication, comprising:
receiving an audio signal;
generating a first combined signal by mixing the audio signal with a noise signal;
generating a negative noise signal according to the noise signal;
generating a second combined signal according to the first combined signal and the negative noise signal; and
determining if the second combined signal matches a reference audio signal.

15. The method of claim 14, wherein, if the second combined signal matches the reference audio signal, the audio signal is determined to be authentic.

16. A system for user authentication, comprising:
a sending unit to receive an audio signal and to generate a first combined signal according to the audio signal and a noise signal; and
a receiving unit to receive the first combined signal, to generate a negative noise signal, and to determine if a second combined signal matches a reference audio signal,
wherein the second combined signal includes the first combined signal and the negative noise signal.

17. The system of claim 16, wherein the sending unit comprising:
an operating unit to generate a noise signal; and
a noise output unit to generate a first combined signal according to a received audio signal and the noise signal and to output the first combined signal.

18. The system of claim 17, wherein the noise output unit comprises:
a digital to analog converter to convert the noise signal to an analog noise signal; and
a mixer to mix the analog noise signal with the audio signal.

19. The system of claim 16, wherein the receiving unit comprising:
a receiving terminal to receive the first combined signal from the sending unit:
a first operating unit to generate a noise signal;
a noise cancellation unit to generate a negative noise signal according to a noise signal and to generate a combined signal according to the first combined signal, the noise signal, and the negative noise signal;
wherein the first operating unit determines the first combined signal is authentic if the noise signal is attenuated by the negative noise signal and if the first combined signal matches a reference audio signal.

20. A method for user authentication, comprising:
receiving an audio signal;
generating a noise signal;
generating a first mixed signal according to the audio signal and the noise signal; and
transmitting the first mixed signal to an authentication device for user authentication.

21. A method for user authentication, comprising:
receiving a first mixed signal including an audio signal and a noise signal from a device;
generating a negative noise signal;
generating a second mixed signal according to the negative noise signal and the first mixed signal; and
determining if the second mixed signal corresponds to a reference audio signal.

22. The method of claim 21, further comprising:
determining if a user is an authorized user if the second mixed signal matches the reference audio signal.
